(19) United States
(12) Patent Application Publication
(10) Pub. No.: US 2007/0299800 A1
(43) Pub. Date: Dec. 27, 2007

(54) Industrial Information Technology (It) On-line Intelligent Control of Machines in Discrete Manufacturing Factory

(76) Inventors: Deia Salah-Eldin Bayoumi, Center Valley, PA (US); Danny E. Julian, Willow Spring, NC (US)

Correspondence Address: Paul Katterle;ABB Inc., 29801 Euclid Avenue, Wickliffe, OH, 44092, US

(21) Appl. No.: 10/577,166

(22) PCT Filed: Oct. 31, 2003
(86) PCT No.: PCT/US03/34977

§ 371 Date: Sep. 10, 2007

(51) Int. Cl. G06N 5/02; G06F 17/00

(52) U.S. Cl. 706/47; 700/104

(57) ABSTRACT

The invention contemplates a system and method offering control and management of manufacturing resources (Machine 1, Machine 2 . . . Machine n) to obtain optimal manufacturing capacities and to avoid manufacturing down-time currently realized through manual operation and control of manufacturing resources. In an illustrative implementation, the present invention contemplates an exemplary control computing application (180) operating in a computing environment (100) which communicates with, cooperates with, and provides control over at least one manufacturing resource (e.g. manufacturing machine—Machine 1, Machine 2, . . . Machine n). The computing application (180) provides at least one instruction set (110′) for use in controlling the manufacturing resource. The communication of the instruction set may be realized local to the manufacturing resource, remotely from the manufacturing resource, or some combination thereof.

### FIELD OF THE INVENTION

The invention relates to the field of discrete manufacturing, and more particularly, to the control of discrete manufacturing operations through the use of an intelligent computing application.

### BACKGROUND OF THE INVENTION

Manufacturing of any detailed product is a complex process that requires extensive co-ordination between various entities, both within the same organization and outside the organization. Such manufacturing includes material need determinations, cost negotiations, material availability determinations, and warehousing considerations, just to name a few. Each of these entities typically is responsible for discrete portions of the manufacturing process, including order processing, supplier integration, and process feedback. It follows, therefore, that manufacturing requires getting the right information to the right place at the right time. Today, some of discrete entities or processes of the manufacturing process are automated computing systems. However, the communication and integration among the various entities is lacking. Often this lack of integration is a result of the various different entities that are responsible for the many different aspects of the overall manufacturing process. As a result, completing the entire manufacturing process often requires extensive human interaction between each of the various discrete entities or processes.

In addition, the entity that is ultimately responsible for the end product often is at the mercy of the individual material suppliers. Yet, often the communication to the end product manufacturer from the discrete entities is inconsistent. This inconsistent communication leads to missed production deadlines and eventually the arduous process of identifying new suppliers. In addition, inventories kept by the end product manufacturer often have low visibility, such that material acquisition requests often come too late, especially for long lead time material items.

Moreover, coordination and control of the manufacturing processes across an enterprise having geographically disparate manufacturing locations poses several challenges which are not currently addressed. With human intervention a loose management of critical manufacturing data and, more importantly, management over manufacturing machinery results. That is, an enterprise having two manufacturing plants producing the same product may not be optimized to operate in a manner so that the capacities of manufacturing equipment for these plants compliment each other. Currently manual decision making is required to first identify complimentary resources and second to coordinate manufacturing tasks among such resources to reach optimal manufacturing. Furthermore, current practices call for the manual operation or local programming of manufacturing resources (e.g. machines). Such convention generally requires at least one operator per machine and increases the chances of errors and loss of materials.

Therefore, there is a need to provide automation and communication among the discrete manufacturing processes in real-time, both local and remotely to manufacturing resources to obtain optimal and error free manufacturing of products.

### SUMMARY OF THE INVENTION

The invention contemplates a system and method offering control and management of manufacturing resources to obtain optimal manufacturing capacities and to avoid manufacturing down-time currently realized through manual operation and control of manufacturing resources. In an illustrative implementation, the present invention contemplates an exemplary control computing application operating in a computing environment which communicates with, cooperates with, and provides control over at least one manufacturing resource (e.g. manufacturing machine). The computing application provides at least one instruction set for use in controlling the manufacturing resource. The communication of the instruction set may be realized local to the manufacturing resource, remotely from the manufacturing resource, or some combination thereof.

Further to the illustrative implementation, the exemplary control computing application controls machines in a discrete manufacturing factory. The dispatching between the computing application and a machine unit is performed based on a either a local decision that is made by intelligent interface devices found at each of machine unit or group of machine units. The interface devices are preprogrammed with job scenarios that are provided by cooperating planning systems, manufacturing optimization routines, or through manual input. The scenarios are dynamic, adaptable, and customizable being easily adjusted or changed through reprogramming of the interface devices by the exemplary control computing application which is communicated over a communications infrastructure which communicatively links the exemplary control computing application with the machine units.

Additionally, the described dispatching may be accomplished between the exemplary control computing application and machine units using a hybrid scheme that combines a central decision made by an integrated cooperating manufacturing computing application with a local decision that is performed by intelligent interface devices found at each of the manufacturing units. The priority of control schemes is set according to some pre-defined rules that govern the manufacturing process. The central and local control decisions are communicated by the control computing application to the machine units over a communications infrastructure that communicatively links the exemplary control computing application with the machine units.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1 is a block diagram of an exemplary computing system that may support the present invention;

FIG. 1a is a block diagram of an exemplary network environment in which the present invention may be employed;

FIG. 1b is a block diagram illustrating the cooperation of the exemplary control computing application with manufacturing resources;

FIG. 2 is a block diagram of an integrated discrete manufacturing system using local control;

FIG. 3 is a block diagram of an integrated discrete manufacturing system using hybrid control;

FIG. 4 is a flow diagram illustrating an exemplary ordering process in accordance with the present invention;

### DETAILED DESCRIPTION OF ILLUSTRATIVE EMBODIMENTS

Illustrative Computing Environment

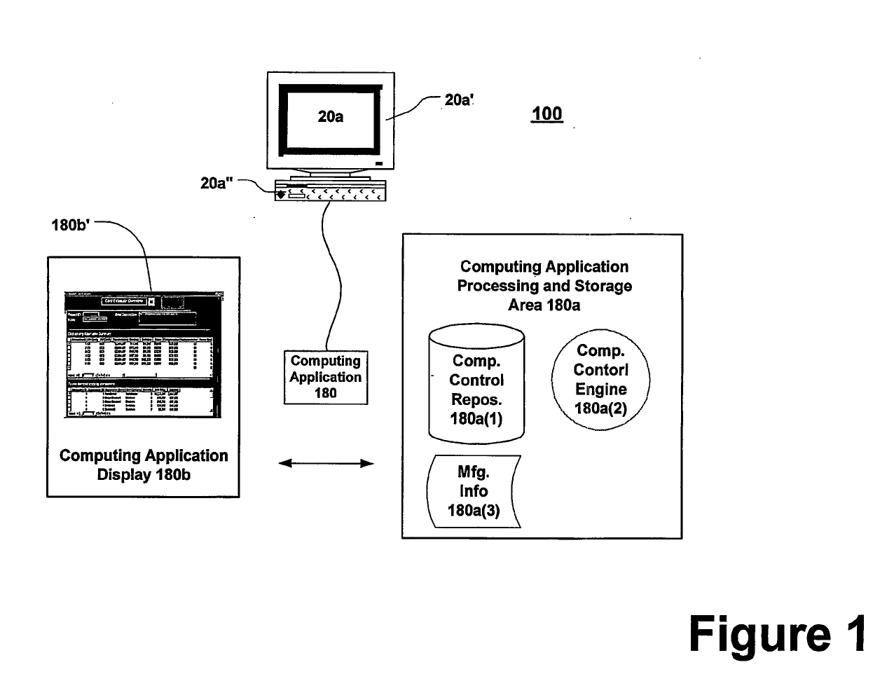

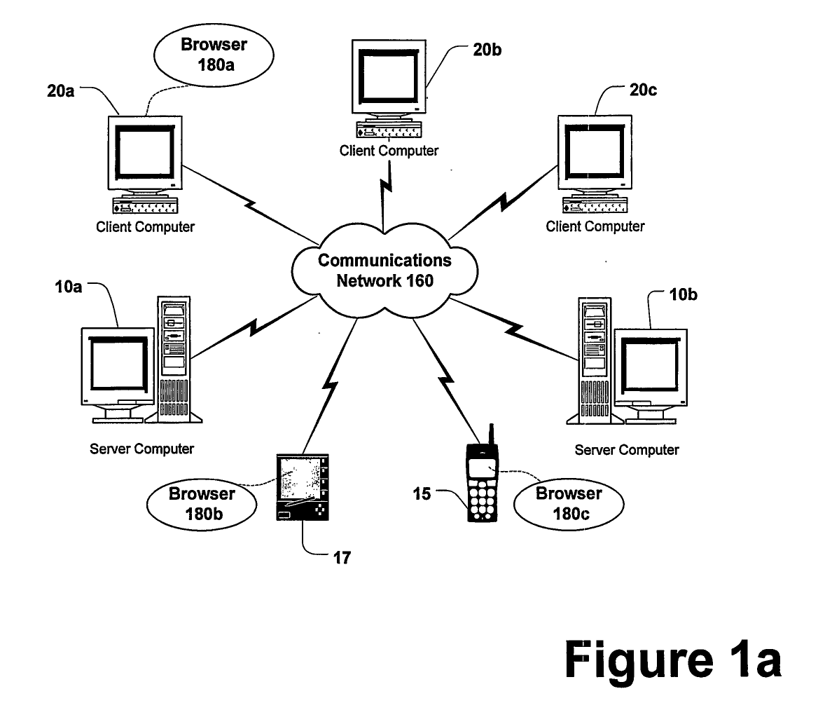

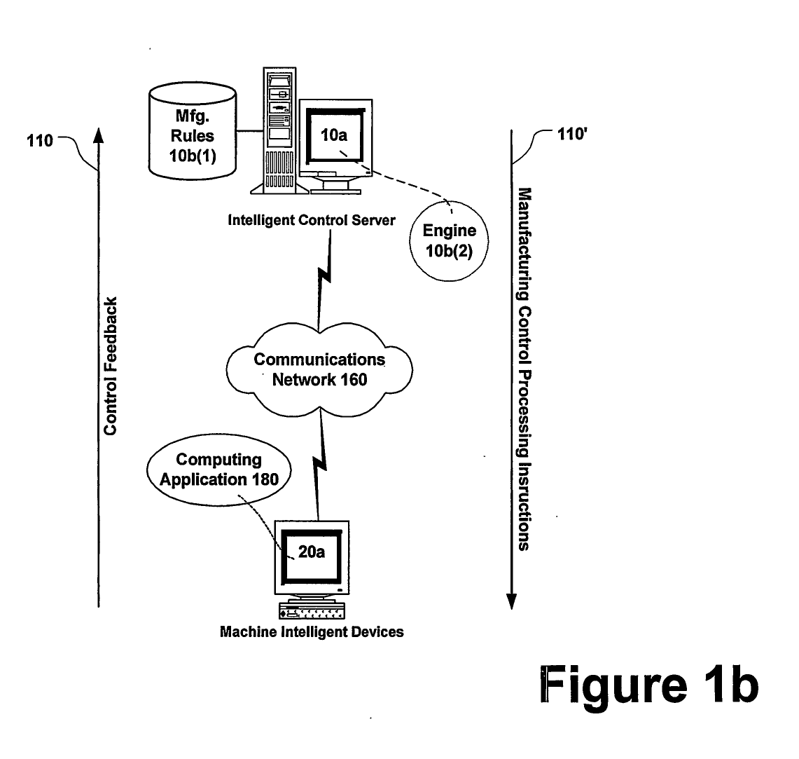

FIG. 1 shows computing system 100 that may support the present invention. Computing system 100 comprises computer 20a that may comprise display device 20a′ and interface and processing unit 20a″. Computer 20a may support computing application 180. As shown, computing application 180 may comprise computing application processing and storage area 180 and computing application display 180b. Computing application processing and storage area 180a may contain manufacturing computer control rules and instructions repository 180a(1), manufacturing computer control engine 180a(2), and manufacturing information 180a(3). Similarly, computing application display 180b may comprise display content 180b′. In operation, a participating user (not shown) may interface with computing application 180 through the use of computer 20a. The participating user (not shown) may navigate through computing application 180 to input, display, and generate data representative of power system manufacturing optimization. Manufacturing resource optimization solutions and analysis may be created by computing application 180 using the manufacturing computer control rules and instructions repository 180a(1), manufacturing computer control engine 180a(2), and manufacturing information 180a(3) of computing application processing and storage area 180a and shown to a participating user (not shown) as display content 180b′ on computing application display 180b.

Illustrative Computer Network Environment

Computer 20a, described above, can be deployed as part of a computer network. In general, the above description for computers applies to both server computers and client computers deployed in a network environment. FIG. 1a illustrates an exemplary network environment, with a server in communication with client computers via a network, in which the present invention may be employed. As shown in FIG. 1a, a number of servers 10a, 10b, etc., are interconnected via a fixed-wire or wireless communications network 160 (which may be a LAN, WAN, intranet, the Internet, or other computer network) with a number of client computers 20a, 20b, 20c, or computing devices, such as, mobile phone 15, and personal digital assistant 17. In a network environment in which the communications network 160 is the Internet, for example, the servers 10 can be Web servers with which the clients 20 communicate via any of a number of known communication protocols, such as, hypertext transfer protocol (HTTP) or wireless application protocol (WAP). Each client computer 20 can be equipped with browser 180a to gain access to the servers 10. Similarly, personal digital assistant 17 can be equipped with browser 180b and mobile phone 15 can be equipped with browser 180c to display and receive various data.

In operation, a participating user (not shown) may interact with a computing application running on a client computing devices to generate manufacturing resource optimization solutions for discrete manufacturing environments. The optimization solutions may be stored on server computers and communicated to cooperating users through client computing devices over communications network 160. A participating user may create, track, manage, and store manufacturing solutions and cost analysis information by interfacing with computing applications on client computing devices. These transactions may be communicated by client computing devices to server computers for processing and storage. Server computers may host computing applications for the processing of optimization information relevant to discrete manufacturing environments.

Thus, the present invention can be utilized in a computer network environment having client computing devices for accessing and interacting with the network and a server computer for interacting with client computers. However, the systems and methods providing resource optimization as described by the systems and methods disclosed herein can be implemented with a variety of network-based architectures, and thus should not be limited to the example shown. The systems and methods disclosed herein will be described in more detail with reference to a presently illustrative implementation.

Manufacturing Optimization Solution Generation

FIG. 1b shows the cooperation of various computing elements when generating manufacturing resource optimization for discrete manufacturing environments in a computing environment. Cooperating machines through machine intelligent devices 20a may employ computing application 180a to send control feedback data to intelligent control server 10a over communications network 160. In response, intelligent control server 10a may process the request by cooperating with adaptable and updateable machine control computer rules and instructions data store 10b(1), and adaptable and updateable machine control computer engine 10b(2) to generate and communicate manufacturing control processing instructions. The manufacturing control processing instructions can then be communicated to machine intelligent devices 20a over communications network 160. At machine intelligent devices 20a, the manufacturing control processing information is processed for execution on cooperating machines (not shown).

In the herein provided illustrative implementation, intelligent devices are depicted as computers. Such depiction is merely exemplary as machine intelligent devices 20a may comprise one or more computing elements that may or may not be integrated with cooperating machines.

Overview

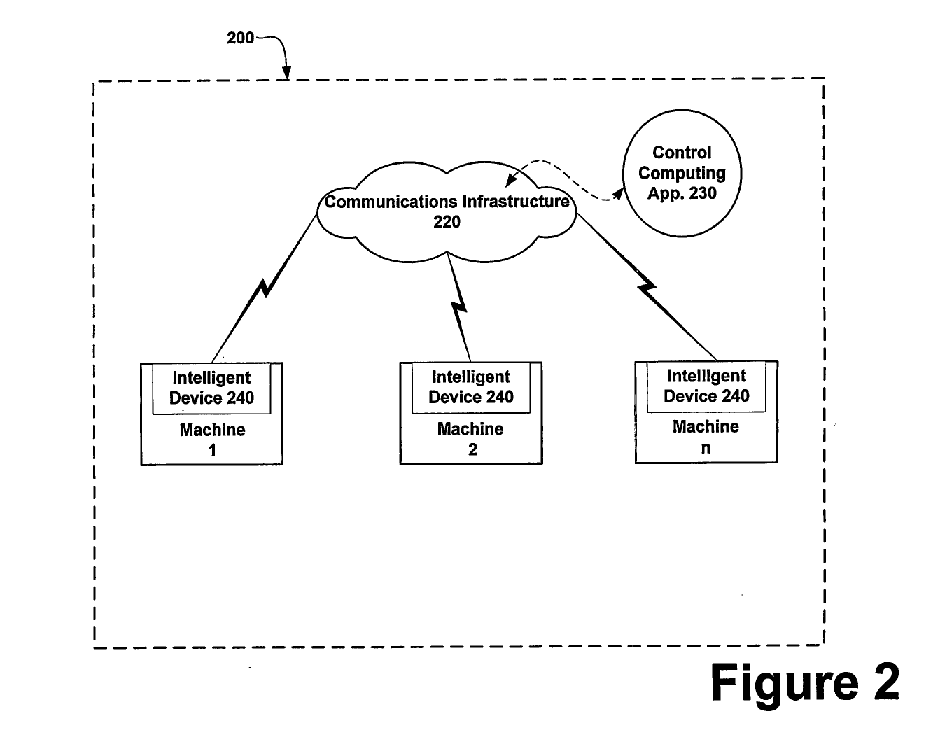

The invention contemplates a technique for providing intelligent control over machine units or groups of machine units in a discrete manufacturing environment such that manufacturing resources are optimized and to avoid costly manufacturing down time. FIG. 2 is a block diagram of an manufacturing control system 200, according to the invention. It should be appreciated that the block diagram shown in FIG. 2 is just one example of a technique for accomplishing the invention. FIG. 2 is not meant to be the exclusive example, but is provided for the purpose of understanding the invention.

As is shown in FIG. 2, manufacturing control system 200 comprises control computing application 230 in communication with machine 1, machine 2, and other machines up to and including machine n using communications infrastructure 220. Machine 1, machine 2, to machine n include intelligent device 240. In the provided illustrative implementation, intelligent devices 240 comprise a computing element cooperating with the exemplary machines to have control over one or more functions of the exemplary machines. Intelligent devices may include but are not limited to one or more data acquisition devices and controller circuits. In operation, control computing application 230 having at least one instruction set (not shown) communicates rules and instructions to machine 1, machine 2, and up to and including machine n over communications infrastructure 220 through intelligent devices 240. Responsive to such instructions and/or rules, intelligent devices 240 process the rules and/or instructions such to execute the rules and/or instructions to the machine with which it cooperates (e.g. machine 1, machine 2, . . . machine n). The instructions are executed and intelligent devices monitor the cooperating machines to determine if errors occurred or proper execution persisted. In either case, data about the execution of the provided instruction and/or rule is communicated back to control computing application 230 over communications infrastructure 220. Control computing application processes the feedback information to determine what additional/new instructions/rules are to be provided each of the machines.

In operation, control computing application relies on at least one heuristic or predefined rule set (e.g. decision making logic) when providing a particular instruction or set of instructions to each of the machines. That is, a discrete manufacturing environment may comprise two machines for making transformer windings and two machines for coating the windings with an insulative coating. Control computing application 230 would be in communication with the winding and coating machines using a communications infrastructure (e.g. communications infrastructure 220) via intelligent devices cooperating with each of the winding and coating machines. Moreover, the control computing application may be pre-configured with at least one rule set such that the winding machines are run in parallel on operating at 40% capacity and the other at 60% capacity, wherein one coating machine is offline and is being repaired and the other machine is operating at 70% capacity. Based on pre-calculated manufacturing rules and heuristics, control computing application may respond to a request to increase capacity of winding production by tasking the winding machines to produce more windings. However, the increase in capacity for the winding machines will be limited by the control computing application such that the coating machine does not operate beyond a 100% capacity. In having intelligence about all of the cooperating manufacturing resources (i.e. machines) of a discrete manufacturing environment, control computing application is positioned to control manufacturing resources in line with intended manufacturing goals and rules.

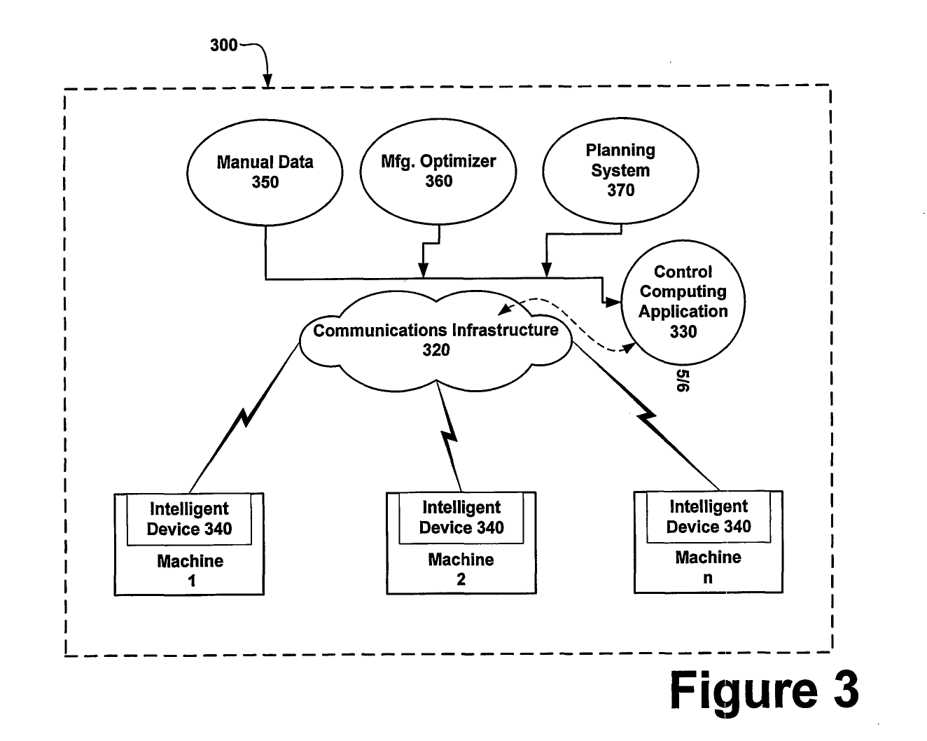

FIG. 3 shows a different illustrative implementation of an manufacturing control system 300 wherein control instructions are determined on both the local level and through the use of external manufacturing resources. In such hybrid system, decision making is balanced between local information and external information (central information) when controlling machine units or groups of machine units in a discrete manufacturing environment. As is shown, manufacturing control system 300 comprises control computing application 330, communications infrastructure 320, machine 1, machine 2, up to and including machine n, intelligent devices 340 and additional control resources manual data 350, manufacturing optimizer 360, and planning system 370. Similar to the manufacturing control system 200 operation, control computing application 330 communicates with machine 1, machine 2, . . . machine n using communications infrastructure 320 via intelligent devices 340. However, unlike system 200, manufacturing control system 300 relies on additional control resources such as manual data 350, manufacturing optimizer 360, and planning system 370 when deciding which instructions and/or rules to communicate to each of the machines. Additional control resources are processed in conjunction with local feedback data obtained from the machines to determine which instruction/rule to communicate to each of the machines for execution. The additional resources are relied upon as they provide intelligence (data) about manufacturing activities across various manufacturing facilities of an enterprise having numerous manufacturing resources that are geographically disparate.

Specifically, manual data 350 is data provided by machine operators, engineers, and/or management to affect the manufacturing process. Such data may be required as certain business, engineering, and/or operational observations and/or needs come to light that require one or more changes to the manufacturing process. Manufacturing optimizer 360 comprises of one or more algorithms or computing elements that process data according to some predefined rule set as part of optimization efforts to optimize one or more of the manufacturing processes. Such optimization may include capacity determination, time for manufacturing, distribution of raw materials, etcetera. Planning system 370 may comprise one or more algorithms or computing applications which track project planning. Planning system 370 data may be used by control computing application 330 such that project planning and actual manufacturing are brought into congruence. By doing so, better control over project goals and milestones may be achieved.

Additional control resources may be required as two geographically disparate manufacturing plants that manufacturing the have the capability of manufacturing the same component are not aware of each other's manufacturing processes and associated manufacturing data leading to wasted capacities and wasted time. For example, an enterprise may have a first manufacturing plant to produce windings and a second manufacturing plant to produce wire. However, the second manufacturing plant with some slight retooling can also produce windings. In the example, it is assumed that the first plant is at full capacity and the second is not. Also new orders require the manufacture of volumes of windings. However, the winding plant is at full capacity. Using additional control resources, control computing application 330 operating to control the machines of the second manufacturing plant communicates instructions to such machines to start producing windings instead of wire. Hence, across an enterprise, capacity that would have been previously not utilized is now utilized to the benefit of producing products to meet new orders that increases customer satisfaction. Moreover, revenues for such enterprise are maximized as the plants are operating at full capacities. It is appreciated by having non-local data act as input to local manufacturing resources, manufacturing is optimized, project planning is realized, and machine control is rendered more relevant.

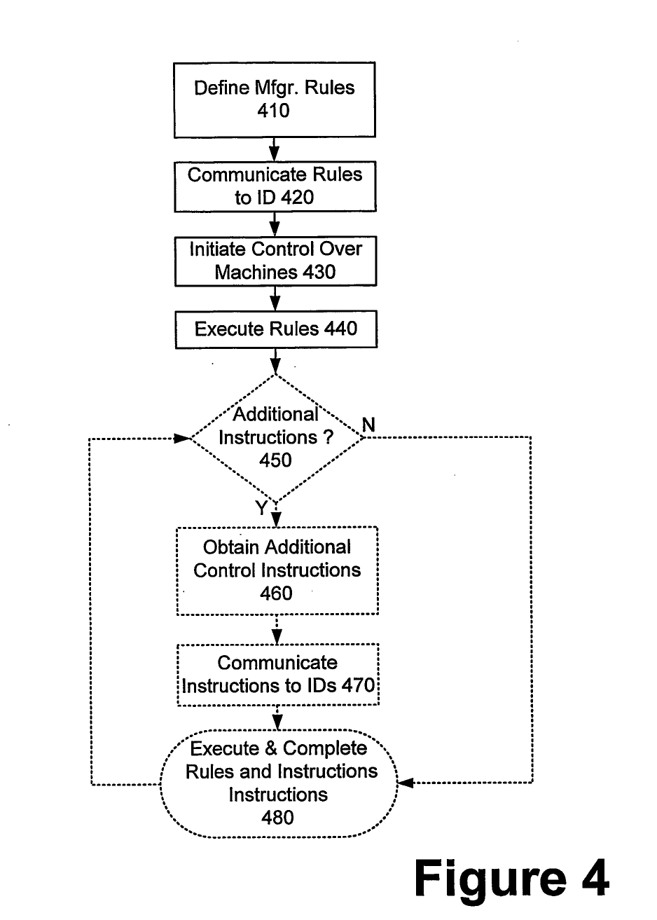

FIG. 4 shows the processing performed to realize intelligent control of machines in a discrete manufacturing environments. As is shown, processing begins at block 410 where rules of the discrete manufacturing environment are determined. From there processing proceeds to block 420 where the rules are communicated to one or more intelligent devices residing on one or more machines of an illustrative and exemplary discrete manufacturing environment. The intelligent devices respond by providing access and control over the machine(s) with which it cooperates at block 430. The predetermined rules of block 410 are then executed at block 440.

A check is then performed at block 450 to determine if additional rules or instructions are required. In the instance that such rules are required or are being provided. If such rules are required, processing proceeds to block 460 where additional control instructions are obtained. Such instructions may be obtained from a variety of resources that be internal or external to a manufacturing environment. Such resources include but are not limited to other computing applications directed to other areas of manufacturing (i.e. planning systems), manual data entry, and optimization routines designed to optimize manufacturing operations. From there processing proceeds to block 470 where the additional instructions are provided to cooperating machines of the illustrative manufacturing environment. Processing then proceeds to block 480 where the additional instructions are then executed by the machines. As is shown, processing then reverts to block 45 and proceeds there from. However, if at block 450 it is determined that additional instructions are not required, processing proceeds to block 480 and proceeds there from.

It is appreciated that blocks 450, 460, 470, 480 and their associated connectors are presented in dashed lines. This is to illustrate the notion that the present invention may operate inclusive and/or exclusive of such steps when realizing intelligent control over machines in a discrete manufacturing environment. In the instance that such steps are excluded, the present invention engages in local control (i.e. control within a particular manufacturing facility) receiving no external inputs to provide rules and instructions for control, rather using data local to the machines of a particular manufacturing facility control decision making processes. Alternatively, the present invention contemplates processing involving the use of external influences (i.e. central data) when performing control decision making processes. Such processing would include blocks 450, 450, 470, 480 and their associated connectors.

In sum, the herein described systems and methods provide intelligent control over machines in a discrete manufacturing environment. It is understood, however, that the invention is susceptible to various modifications and alternative constructions. There is no intention to limit the invention to the specific constructions described herein. On the contrary, the invention is intended to cover all modifications, alternative constructions, and equivalents falling within the scope and spirit of the invention.

It should also be noted that the present invention may be implemented in a variety of computer environments (including both non-wirless and wireless computer environments), partial computing environments, and real world environments. The various techniques described herein may be implemented in hardware or software, or a combination of both. Preferably, the techniques are implemented in computer programs executing on programmable computers that each include a processor, a storage medium readable by the processor (including volatile and non-volatile memory and/or storage elements), at least one input device, and at least one output device. Program code is applied to data entered using the input device to perform the functions described above and to generate output information. The output information is applied to one or more output devices. Each program is preferably implemented in a high level procedural or object oriented programming language to communicate with a computer system. However, the programs can be implemented in assembly or machine language, if desired. In any case, the language may be a compiled or interpreted language. Each such computer program is preferably stored on a storage medium or device (e.g., ROM or magnetic disk) that is readable by a general or special purpose programmable computer for configuring and operating the computer when the storage medium or device is read by the computer to perform the procedures described above. The system may also be considered to be implemented as a computer-readable storage medium, configured with a computer program, where the storage medium so configured causes a computer to operate in a specific and predefined manner.

Although an exemplary implementation of the invention has been described in detail above, those skilled in the art will readily appreciate that many additional modifications are possible in the exemplary embodiments without materially departing from the novel teachings and advantages of the invention. Accordingly, these and all such modifications are intended to be included within the scope of this invention. The invention may be better defined by the following exemplary claims.

What is claimed:

1. A system providing control over manufacturing resources of a discrete manufacturing environment, comprising:
a data store, the data store having manufacturing rules for the discrete manufacturing environment; and
a manufacturing control engine, the control engine cooperating with the data store to obtain manufacturing rules for processing to generate manufacturing control instructions.

2. The system as recited in claim 1, further comprising a communications network, the communications network cooperating with the manufacturing control engine to communicate data representative of discrete manufacturing control information to cooperating manufacturing resources.

3. The system as recited in claim 2, wherein the communications network comprises any of: local area network, wide area network, extranet, intranet, peer-to-peer networks, and the Internet.

4. The system as recited in claim 3, wherein the communications network is wireless and/or fixed wire.

5. The system as recited in claim 1, wherein the manufacturing control engine comprises a computing application having one or more instruction sets to instruct a computing environment to process data representative of discrete manufacturing rule information.

6. The system as recited in claim 5, wherein the manufacturing rule information comprises any of: manufacturing resource capacity information, time for manufacturing information, manufacturing resource specifications, raw material information, and manufacturing environment information.

7. The system as recited in claim 1, wherein the manufacturing control engine cooperates with a plurality of manufacturing resources to communicate control information for use in one ore more manufacturing processes.

8. The system as recited in claim 8, wherein the manufacturing control engine receives data from additional control resources comprising any of manual data, manufacturing optimization information, and planning information to generate at least one instruction set to cooperating manufacturing resources for execution.

9. The system as recited in claim 8, wherein the manufacturing control engine utilizes an agent that executes one or more of artificial intelligence techniques to obtain the additional control resource data.

10. The system as recited in claim 1, wherein the manufacturing control instructions is communicated to intelligent devices cooperating with at least one manufacturing resource.

11. The system as recited in claim 8, wherein the additional control resource data is is provided to the manufacturing control engine over a communications infrastructure.

12. A method for generating manufacturing control instructions for manufacturing resources of a manufacturing environment comprising the steps of:
receiving request for the manufacture of a product or product component; and
processing the request by a manufacturing control engine, the manufacturing control engine having at least one instruction set to process data according to predefined manufacturing rules.

13. The method as recited in claim 12, wherein the further comprising communicating the processed data to at least one cooperating manufacturing resource.

14. The method as recited in claim 13, wherein the communicating step comprises establishing communications over a communications network with the manufacturing resource.

15. The method as recited in claim 14, further comprising retrieving from a cooperating data store data manufacturing rules for the manufacturing environment.

16. The method as recited in claim 15, further comprising receiving data from cooperating additional control resources comprising any of manual data, manufacturing optimization application, and planning systems for processing and to generate the manufacturing instructions.

17. A computer readable medium having computer readable instructions to instruct a computer to perform the method as recited in claim 12.

18. A method to generate manufacturing control instructions for manufacturing resources comprising:
providing a manufacturing control engine, the manufacturing control engine capable of receiving and processing data to generate manufacturing control instructions.

19. The method as recited in claim 18 further comprising, providing a data store, the data store cooperating with the manufacturing control engine to manufacturing rules and manufacturing environment conditions.

20. The method as recited inc claim 18 further comprising, providing a communications network, the communication network cooperating with manufacturing control engine to communicate manufacture control instructions to cooperating manufacturing resources.

21. In an information technology system providing communication of data among a global power distribution equipment manufacturer enterprise, a module manufacturing control comprising:
a communications network, the communication network capable of receiving and transmitting data representative of power distribution equipment manufacturing;
a data store, the data store having data representative of power distribution equipment manufacturing;
a manufacturing control applet, the manufacture control applet cooperating with the communications network and the data store to receive data representative of power distribution manufacturing data, comprising any of power distribution system market information, design information, facilities capacity, planning, and materials information, for processing, such processing comprising any of generating manufacturing control instructions to control at least one cooperating manufacturing resource, wherein the applet communicates with the manufacturing resource through an intelligent device capable of monitoring the manufacturing resource to obtain operational information for communication back to the manufacturing control applet, and wherein the manufacturing control applet uses the operational information to identify additional instructions for execution by the cooperating manufacturing resource.

22. The system as recited in claim 21, wherein the data store has data representative of local and remote manufacturing resources and enterprise data comprising any of planning information, project information, and manufacturing optimization iformation.
